(19) United States
(12) Patent Application Publication
(10) Pub. No.: US 2015/0012612 A1
(43) Pub. Date: Jan. 8, 2015

(54) PROMPT METHOD FOR ADDING QUICK LINK IN BROWSER, DEVICE AND SYSTEM THEREOF

(71) Applicant: Tencent Technology (Shenzhen) Company Limited, Shenzhen (CN)

(72) Inventor: Jing LIU, Shenzhen (CN)

(73) Assignee: Tencent Technology (Shenzhen) Company Limited

(21) Appl. No.: 14/494,037

(22) Filed: Sep. 23, 2014

Related U.S. Application Data
(63) Continuation of application No. PCT/CN2014/072610, filed on Feb. 27, 2014.

(30) Foreign Application Priority Data
Jun. 5, 2013 (CN) 201310221031.5

(51) Int. Cl. H04L 29/08; G06F 17/30

(52) U.S. Cl. CPC H04L 67/02; G06F 17/3089; H04L 67/22; H04L 67/26
USPC 709/217

(57) ABSTRACT

A prompt method for adding a quick link in a browser includes: obtaining a historical internet address database at the end of a period and counting the number of loadings of each historical internet address in the historical internet address database in the period; extracting the historical internet address with the number of loadings larger than a preset number threshold; and sending a push message based on the extracted historical internet address to send a prompt of adding the quick link to the user, wherein the push message is adapted to prompt the user to set the historical internet address as a quick link internet address; where the historical internet address database is adapted to record internet addresses of web pages, where the web pages are displayed on the foreground by a browser during the period and display durations of the web pages is longer than a preset duration threshold.

The present application is a continuation application of PCT international application PCT/CN2014/072610 filed on Feb. 27, 2014, which claims the priority to Chinese Patent Application No. 201310221031.5, entitled as “PROMPT METHOD FOR ADDING QUICK LINK IN BROWSER, DEVICE AND SYSTEM THEREOF”, filed on Jun. 5, 2013 with State Intellectual Property Office of People's Republic of China, both of which are incorporated herein by reference in their entireties.

### TECHNICAL FIELD

The present disclosure relates to computer application technologies, and in particular, to a prompt method for adding a quick link in a browser, a prompt device and a prompt system thereof.

### BACKGROUND

With the development of computer technologies, network technologies and intelligent terminal devices, people may open a browser anytime and anywhere through a device such as a computer, a smart phone and a tablet computers, etc., in order to check updated news, know about stock quotations, inquiry various business information, etc. In this way, people may know about all kinds of information quickly and acquire all kinds of knowledge, which is significantly advantageous for the work, study and life of people.

Currently, a Favorites mechanism is provided in a browser, in which quick link internet addresses are set. A user may manually add a favorite and usually concerned internet address into the Favorites as the quick link address. The user opens the internet address by clicking a quick button corresponding to the internet address in the Favorites of the browser, rather than inputting the internet address in the address bar of the browser. Thus, the browser may automatically initiate a request for opening a web page, and the web page corresponding to the internet web address in the Favorites is accordingly opened.

In an existing browser, the user needs to manually add favorite internet addresses into the Favorites. How to automatically obtain, through statistics based on browsing habits of the user, the internet addresses which may be favorite and be concerned by the user becomes a technical focus.

### SUMMARY

A prompt method for adding a quick link in a browser, a prompt device and a prompt system thereof are provided according to embodiments of the disclosure, to intelligently and automatically perform statistics for the internet addresses of web pages browsed by the user and provide a prompt based on browsing habits of a user. Thus, it is advantageous for the user to add quick link addresses.

A prompt method for adding a quick link in a browser is provided according to an embodiment of the disclosure. The method includes:

obtaining a historical internet address database set for a target user at the end of a period, and counting the number of loadings of each historical internet address in the historical internet address database in the period;

extracting the historical internet address with the number of the loadings larger than a preset number threshold; and

sending a push message based on the extracted historical internet address to send to the target user a prompt of adding the quick link when the browser in a terminal of the target user is opened, where the push message is adapted to prompt the user to set at least one extracted historical internet address as a quick link internet address;

where the historical internet address database is adapted to record the internet addresses of web pages, where the web pages are displayed on a foreground by a browser during the period and display durations of the web pages are longer than a preset duration threshold.

Another prompt method for adding a quick link in a browser is further provided according to an embodiment of the disclosure. The method includes:

obtaining an internet address of a web page displayed on the browser, in the case that the browser is opened;

detecting a display duration of the web page displayed on a foreground by the browser; and

in the case that the display duration of the web page is equal to a preset duration threshold, sending the internet address to a server, and obtaining, by the server, a historical internet address database including the internet address.

Correspondingly, a prompt device for adding a quick link in a browser is provided according to an embodiment of the disclosure. The device includes:

a counting module adapted to obtain a historical internet address database set for a target user at the end of a period and count the number of loadings of each historical internet address in the historical internet address database in the period;

an extraction module adapted to extract the historical internet address with the number of loadings larger than a preset number threshold; and

a pushing module adapted to send a push message based on the extracted historical internet address to send a prompt of adding the quick link to the target user when the browser in a terminal of the target user is opened, where the push message is adapted to prompt the user to set at least one extracted historical internet address as a quick link internet address;

where the historical internet address database is adapted to record the internet addresses of web pages, where the web pages are displayed on a foreground by a browser during the period and display durations of the web pages are longer than a preset duration threshold.

Correspondingly, another prompt device for adding a quick link in a browser is provided according to an embodiment of the disclosure. The device includes:

an internet address obtaining module adapted to obtain an internet address of a web page displayed by the browser in the case that the browser is opened;

a duration detection module adapted to detect a display duration of the web page displayed on a foreground by the browser; and

a sending module adapted to, in the case that the display duration is equal to a preset duration threshold, send the internet address to a server, where the server stores the internet address into a historical internet address database of the server.

Correspondingly, a prompt system for adding a quick link in a browser is provided according to an embodiment of the disclosure. The system includes: a user terminal and a server, where

the user terminal is adapted to obtain an internet address of a web page displayed by the browser in the case that the browser is opened; detect a display duration of the web page displayed on the foreground by the browser; in the case that the display duration is equal to a preset duration threshold, send the internet address to the server;

the server is adapted to record the received internet address into a historical internet address database of the server, where the historical internet address database is adapted to record internet addresses of web pages, where the web pages are displayed on the foreground by a browser during a period and the display durations of the web pages are longer than a preset duration threshold;

the server is further adapted to obtain a historical internet address database set for a target user at the end of a period and count the number of loading of each historical internet address in the historical internet address database in the period; extract the historical internet address with the number of loadings larger than a preset number threshold; send a push message based on the extracted historical internet address to send a prompt of adding the quick link to the target user when the browser in a terminal of the target user is opened, where the push message is adapted to prompt the user to set at least one extracted historical internet address as a quick link internet address; and

the user terminal is further adapted to receive the push message generated and sent by the server, and add the push message to the browser and display the push message to the user; in the case that an operation of clicking the push message is received, set at least one clicked historical internet address as the quick link internet address.

According to the embodiments of the disclosure, the number of loadings of each historical internet address browsed by the target user may be counted automatically to automatically prompt the user to set the internet address with a large number of loadings as the quick link internet address, which may be opened directly and rapidly when browsing next time. In this way, the requirement of the user on intelligentized and automatic statistic of quick link internet addresses is satisfied, and it is advantageous for the user to add the quick link internet addresses.

### BRIEF DESCRIPTION OF THE DRAWINGS

For describing technical solutions according to embodiments of the disclosure or in the existing technology more clearly, drawings to be used in the description of the embodiments or the existing technology are described briefly; apparently, the drawings in the description are merely some of the embodiments, other drawings may be obtained by those skilled in the art based on the drawings without inventive efforts.

FIG. 1 is a schematic flow chart of a prompt method for adding a quick link in a browser according to an embodiment of the disclosure;

FIG. 2 is a schematic flow chart of another prompt method for adding a quick link in a browser according to an embodiment of the disclosure;

FIG. 3 is a schematic flow chart of still another prompt method for adding a quick link in a browser according to an embodiment of the disclosure;

FIG. 4 is a schematic flow chart of further another prompt method for adding a quick link in a browser according to an embodiment of the disclosure;

FIG. 5 is a schematic structure diagram of a prompt device for adding a quick link in a browser according to an embodiment of the disclosure;

FIG. 6 is a schematic structure diagram of the obtaining module in FIG. 5;

FIG. 7 is a schematic structure diagram of another prompt device for adding a quick link in a browser according to an embodiment of the disclosure;

FIG. 8 is a schematic structure diagram of an internet address obtaining module in FIG. 7; and

FIG. 9 is a schematic structure diagram of a prompt system for adding a quick link in a browser according to an embodiment of the disclosure.

### DETAILED DESCRIPTION OF THE EMBODIMENTS

A technical solution of embodiments of the disclosure is clearly and completely described hereinafter in conjunction with drawings according to the embodiments of the disclosure; obviously, the described embodiments are merely part of the embodiments, rather than all the embodiments. Any other embodiment obtained by those skilled in the art based on the embodiments of the disclosure without inventive efforts should fall in the scope of protection of the disclosure.

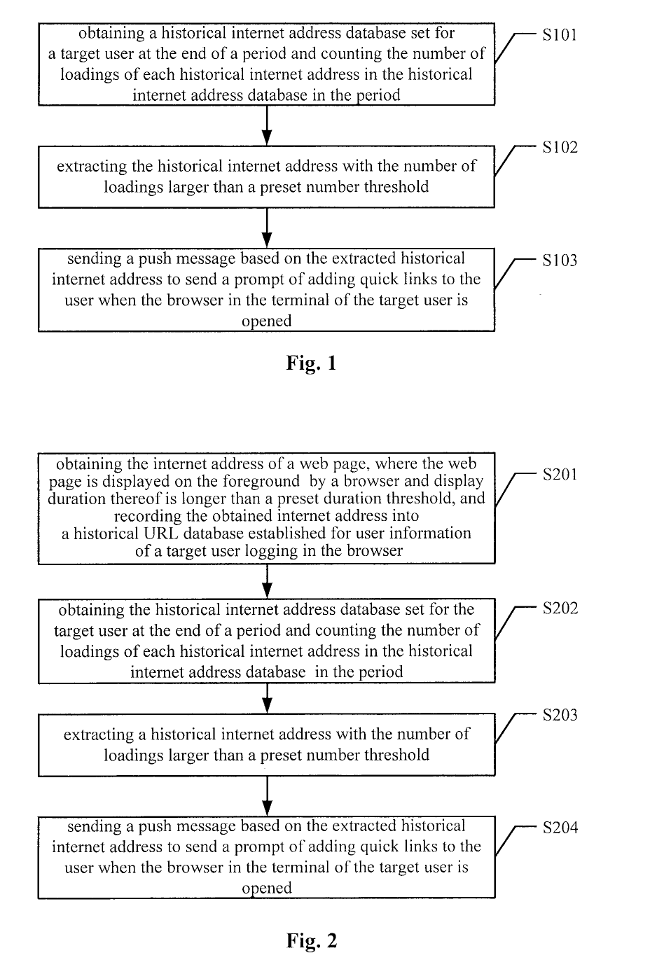

FIG. 1 illustrates a schematic flow chart of a prompt method for adding a quick link in a browser according to an embodiment of the disclosure. The method according to the embodiment may be applied in a server adapted to perform statistical analysis on factors such as user internet surfing behaviors, etc. The method is applied to count and process the internet use of users of various intelligent terminals in which a browser is installed. The method includes steps 101-103.

The step 101 is to obtain a historical internet address database set for a target user at the end of a period and count the number of loadings of each historical internet address in the historical internet address database in the period. The historical internet address database is adapted to record the internet addresses of web pages, where the web pages are displayed on the foreground by a browser during the period and display durations of the web pages is longer than a preset duration threshold.

The end of the period may be determined by setting a timer, or automatically timing based on a system time of a server. The period may be set as 10 days, one month, etc.

The historical internet address database set for the target user may be directly set in the server. The server stores each internet address browsed by a terminal user into the historical internet address database during the period. The simple implementation of storing internet address may include: actively reporting, by the browser, the internet address corresponding to the web page currently accessed and opened by the user to the server when the user browses the web page by a browser in a terminal; and storing, by the server, based on a logged-in user account on the browser, the actively reported internet address into the historical internet address database corresponding to the user account, where the stored internet address is a historical internet address accessed by the user.

Alternatively, the historical internet address database set for the target user may be set in a terminal. In the period, the terminal obtains the internet address corresponding to a web page accessed and opened through a browser in a terminal. Further, the terminal stores, based on a logged-in user account on the browser, the corresponding internet address into the historical internet address database corresponding to the user account. At the end of the period, the terminal reports the whole stored historical internet address database to the server, and the server counts the number of loadings of each internet address in the historical internet address database.

The number of loadings of each internet address in the historical internet address database may be counted with the following approach: according to a storage order of the historical internet addresses in the historical internet address database, comparing a current historical internet address with at least one previous historical internet address one by one; if the current historical internet address is the same as one of previous historical internet addresses, adding 1 to the number of loadings of the previous historical internet address; and by this analogy, obtaining the number of loadings of each historical internet address in the historical internet address database.

The historical internet address includes home page internet addresses of various web portals, forums, etc., and all internet subdomain addresses linked to the home page internet addresses. In the step 101, the number of loadings of each historical internet address is counted.

The historical internet address is an internet address of a web page displayed on the foreground by the browser, where the display durations is longer than the preset duration threshold, for example, longer than one minute. The internet address of the web page which is not displayed on the foreground or displayed with short durations are not processed, because the internet address may be clicked by the user by error, or may be pop-up advertisement, etc. Thus, the time for counting and processing is reduced by removing the internet address.

The step 102 is to extract the historical internet address with the number of loadings larger than a preset number threshold.

The historical internet address with the small number of loadings may be accidentally accessed by the user sometime or on a certain day based on requirements for work, study or life. The historical internet address with the small number of loadings may not be processed or may be deleted. As for the historical internet address with the large number of loadings, for example, some historical internet address are loaded 20 times in a period of 10 days, it may be determined that the user likes and pays attention to those historical internet addresses, and the step 103 will be performed on this historical internet address.

The step 103 is to send a push message based on the extracted historical internet address to send to the user a prompt of adding the quick link when the browser in the terminal of the target user is opened, where the push message is adapted to prompt the user to set at least one extracted historical internet address as a quick link internet address.

The historical internet address with the number of loadings larger than the preset number threshold are extracted at the end of the period; and then in the case that the server detects an access requirement sent when the terminal of the target user opens the browser or a notification of the open of the browser actively reported to the server, the server sends the push message to the terminal of the target user. After receiving the push message, the terminal prompts the user to set at least one extracted historical internet address as the quick link internet address.

Alternatively, the server sends the push message to the terminal of the target user. In this way, when the terminal of the target user opens the browser, the prompt of adding the quick link is directly displayed to prompt the user to set at least one extracted historical internet address as the quick link internet address.

In the case that a lot of historical internet addresses are extracted in the step 102, only one or a few of the historical internet addresses with a largest number of loadings are displayed in one push message.

According to the embodiment of the disclosure, the method is described based on the server. The method according to the embodiment of the disclosure may further be directly applied to the intelligent terminal such as smart phone, tablet computer, etc., which is adapted to count and process the internet use of the user of the intelligent terminal. The intelligent terminal may directly establish a historical internet address database. In the case that the internet address of each web page is loaded by the browser in the intelligent terminal, the intelligent terminal determines whether the web page is displayed on the foreground and a display duration thereof is longer than the preset duration threshold. If the web page is displayed on the foreground and the display duration thereof is longer than the preset duration threshold, the internet address of the web page is directly stored in the historical internet address database; else, the internet address of the web page is not processed. At the end of the period determined based on the timer or the system time, the steps 101-103 are executed. Apparently, the intelligent terminal may distinguish different users based on a user's login information in the browser when the browser in the terminal is used, and the internet addresses of the loaded web pages corresponding to different user information are stored into the historical internet address databases corresponding to different users. The step 101 is executed at the end of the period. That is, the number of loadings of each historical internet address in the historical internet address database corresponding to any target user in the different users may be counted to execute the subsequent steps 102-103.

According to the embodiment of the disclosure, the number of loadings of the historical internet address browsed by the target user may be counted automatically to automatically prompt the user to set the internet address with the large number of loadings as the quick link internet address, which may be loaded directly and rapidly when browsing next time. Thus, the requirement of the user on intelligentized and automatic statistic of quick link internet address is satisfied, and it is advantageous for the user to add the quick link internet address.

Referring FIG. 2, which illustrates a schematic flow chart of another prompt method for adding a quick link in a browser according to an embodiment of the disclosure, the method according to the embodiment may be applied in a server adapted to perform statistical analysis on factors such as user internet surfing behaviors, etc. The method is adapted to count and process the internet use of users of various intelligent terminals in which browsers are installed. The method includes steps 201-204.

The step 201 is to obtain the internet address of web pages, where the web pages are displayed on the foreground by a browser and display durations of the web pages are longer than a preset duration threshold; and record the obtained internet address into a historical internet address database, where the historical internet address database includes user information of a target user logging in the web page in the browser.

In an available implementation of the step 201, the target user initiates a prompt function of a browser by the browser of a terminal, the terminal may send to a server an initiating request carrying a user account of the target user. After receiving the initiating request, the server establishes the historical internet address database based on the user account in the request to store historical internet addresses corresponding to the user account.

Alternatively, when the terminal of the target user reports an internet address at the first time, the server may establish the historical internet address database based on the user account of the target user which is sent together with the reported internet address, in order to store the historical internet addresses corresponding to the user account. The user account of the target user may be an account of a browser application registered by the user.

The internet addresses recorded into the historical internet address database are required to satisfy two conditions: the internet addresses are displayed on the foreground by the browser, and the display durations are longer than the preset duration threshold. Accordingly, some internet addresses generated through wrong clicks of the user or pop-up advertisements may be reduced, and the number of the internet addresses to be subsequently counted is decreased.

According to the embodiment of the disclosure, the step 201 may include: when the browser in the terminal of the target user searches for a key word by a search engine, determining whether the display duration of the web page opened by clicking the internet address from a search result is longer than the preset duration threshold; if the display duration is longer than the preset duration threshold, recording the clicked internet address into the historical internet address database established for the user information of the target user logging in the web page in the browser.

Alternatively, the step S201 may include: detecting an internet address inputted in an address bar of the browser in the terminal of the target user; after the browser loads the web page corresponding to the inputted internet address, in the case that the web page is displayed on the foreground by the browser and the display duration thereof is longer than the preset duration threshold, recording the inputted internet address into the historical internet address database established for the user information of the target user logging in the web page in the browser.

Alternatively, the step S201 may include: detecting an clicked internet address in a site navigation of the browser in the terminal of the target user; after the browser loads the web page corresponding to the clicked internet address in the site navigation, in the case that the web page is displayed on the foreground by the browser and the display duration thereof is longer than the preset duration threshold, recording the clicked internet address into the historical internet address database established for the user information of the target user logging in the web page in the browser.

The step 202 is to obtain the historical internet address database set for the target user, and count the number of loadings of each historical internet address in the historical internet address database at the end of the period.

The step 203 is to extract the historical internet address with the number of loadings larger than a preset number threshold.

The step 204 is to send a push message based on the extracted historical internet address to send a prompt of adding the quick link to the user when the browser in a terminal of the target user is opened, where the push message is adapted to prompt the user to set at least one extracted historical internet address as a quick link internet address.

The implementations of the steps 203-205 may be referred to the description of the embodiment corresponding to FIG. 1, and a repeated description thereof will be omitted here. Similarly, according to the embodiment, the method may be implemented through intelligent terminals such as smart phone, tablet computer, etc.

According to the embodiment, the internet address browsed by the browser in the terminal of the user may be obtained rapidly and filtered initially, and the number of loadings of the historical internet address browsed by the target user may be counted automatically to automatically prompt the user to set the internet address with the large number of loadings as the quick link internet address, which may be loaded directly and rapidly when browsing next time. Thus, the requirement of the user on intelligentized and automatic statistics of the quick link internet addresses is satisfied, and it is advantageous for the user to add the quick link internet addresses.

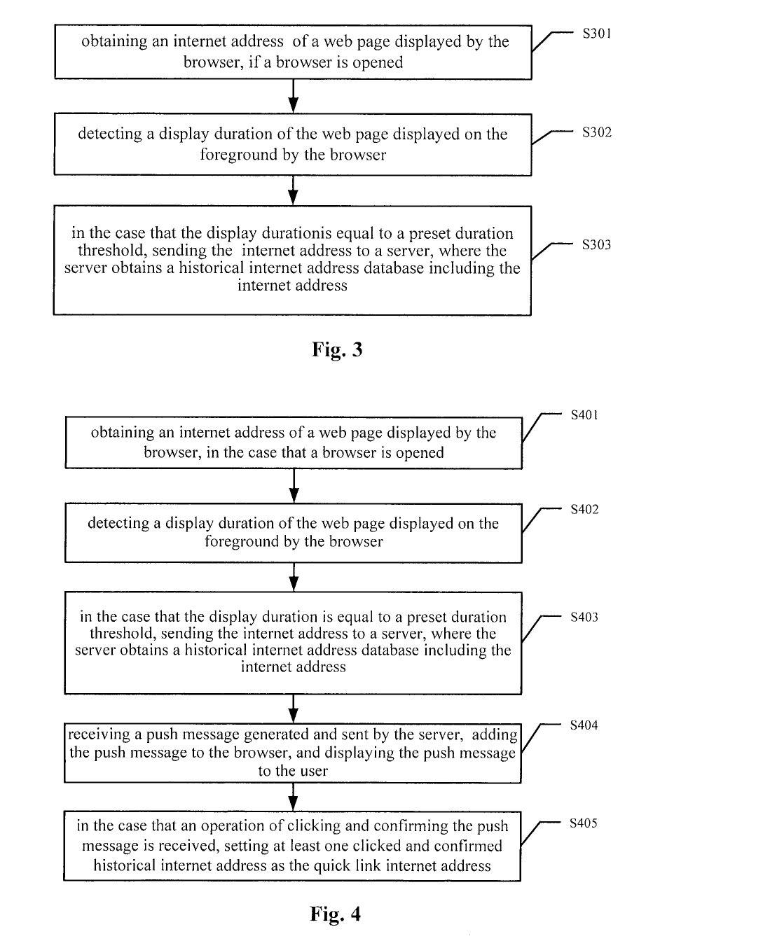

Referring FIG. 3, which illustrates a schematic flow chart of still another prompt method for adding a quick link in a browser according to an embodiment of the disclosure, the method according to the embodiment may be implemented through intelligent terminals such as smart phone, tablet computer, etc. The method includes steps 301-303.

The step 301 is to obtain an internet address of a web page displayed by the browser, in the case that the browser is opened.

A terminal may determine whether the user opens the browser based on system processes, and obtain the internet address currently requested and loaded by the browser based on a running condition of the browser in the kernel.

The step 302 is to detect a display duration of the web page displayed on the foreground by the browser.

The duration may be timed when the requested internet address starts to be displayed on the foreground by the browser.

The step 303 is to, in the case that the display duration is equal to a preset duration threshold, send the currently loaded internet address to a server, and obtaining, by the server, a historical internet address database including the currently loaded internet address.

When the duration in which the web page corresponding to the currently loaded internet address is displayed on the foreground by the browser is longer than the preset duration threshold, the terminal may directly send the currently loaded internet address to the server, and the server stores the currently loaded internet address into the historical internet address database which is located on the server and is preset for the user of the browser. Alternatively, the terminal may firstly store the currently loaded internet address into the historical internet address database of the terminal, then send the historical internet address database including the currently loaded internet address to the server at the end of the period, and the server may accordingly records the historical internet address database including the currently loaded internet address.

Optionally, the step 301 may further include: in the case that the browser searches for a key word by a search engine, obtaining the clicked and loaded internet address from a search result; obtaining the internet address inputted in an address bar of the browser; or obtaining the clicked internet address in a site navigation of the browser.

According to the embodiment, the internet addresses browsed through the browser in the terminal of the user may be obtained rapidly and filtered initially, the filtered internet addresses are sent to the server to automatically prompt the user to set the internet addresses with the large number of loadings as quick link internet addresses. Thus, the requirement of the user on intelligentized and automatic statistics of quick link internet address is satisfied, and it is advantageous for the user to add the quick link internet addresses.

Referring FIG. 4, which illustrates a schematic flow chart of further another prompt method for adding a quick link in a browser according to an embodiment of the disclosure, the method according to the embodiment may be implemented through intelligent terminals such as smart phone, tablet computer, etc. The method includes steps 401-405.

The step 401 is to obtain a internet address of a web page displayed by the browser in the case that the browser is opened.

The step 401 may include: in the case that the browser searches for a key word by a search engine, obtaining the internet address clicked and loaded from a search result; obtaining the internet address inputted in an address bar of the browser; or obtaining the internet address clicked in a site navigation of the browser.

The step 402 is to detect a display duration of the web page displayed on the foreground by the browser.

The step 403 is to, in the case that the display duration of the web page is equal to a preset duration threshold, send the internet address to a server, and obtain, by the server, a historical internet address database including the internet address.

The step 404 is to receive a push message generated and sent by the server, add the push message to the browser, and display the push message to the user, where the push message is adapted to prompt the user to set at least one historical internet address as a quick link internet address.

The step 405 is to, in the case that an operation of clicking and confirming the push message is received, set the at least one clicked and confirmed historical internet address as the quick link internet address.

The server counts the number of the loadings of each internet address in the historical internet address database including the currently loaded internet address, and extracts at least one historical internet address with the number of the loadings larger than a preset number threshold. Then, the push message is generated by the server based on the extracted historical internet address and sent by the server.

In the step 405, the terminal adds the at least one historical internet address clicked and confirmed by the user into Favorites of the browser, and then the quick link internet address is set.

According to the embodiment, the internet addresses browsed by the browser in the terminal of the user may be obtained rapidly and filtered initially; and then the filtered internet addresses are sent to the server to automatically prompt the user to set the internet addresses with the large numbers of loadings as quick link internet addresses. After receiving prompt information from the server, the terminal may display the prompt information to the user, and prompt the user to select at least one internet address from the prompt information as the quick link internet address. In this way, the requirement of the user on intelligentized and automatic statistics of the quick link internet addresses is satisfied, and it is advantageous for the user to add the quick link internet addresses.

A prompt device for adding a quick link in a browser and a prompt system for adding a quick link in a browser according to embodiments of the disclosure are described hereinafter in detail.

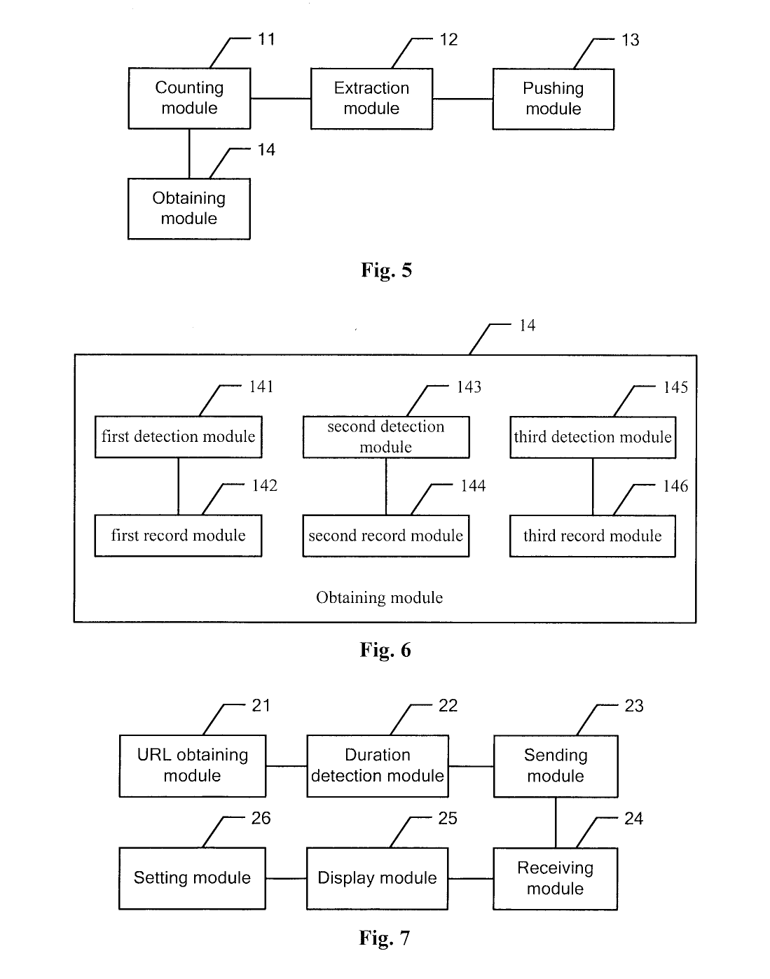

Referring FIG. 5, which illustrates a schematic structure diagram of a prompt device for adding a quick link in a browser according to an embodiment of the disclosure, the device according to the embodiment may be applied in a server adapted to perform statistical analysis on factors such as user internet surfing behaviors, etc. The device is adapted to count and process internet use of users of various intelligent terminals in which a browser is installed. The device includes: a counting module 11, an extraction module 12, and a pushing module 13.

The counting module 11 is adapted to obtain a historical internet address database set for a target user at the end of a period and count the number of loadings of each historical internet address in the historical internet address database in the period.

The extraction module 12 is adapted to extract the historical internet address with the number of loadings larger than a preset number threshold.

The pushing module 13 is adapted to send a push message based on the extracted historical internet address to send a prompt of adding the quick link to the user when the browser in a terminal of the target user is opened, where the push message is adapted to prompt the target user to set at least one extracted historical internet address as a quick link internet address.

The historical internet address database is adapted to record the internet addresses of web pages, where the web pages are displayed on the foreground by a browser during the period and display durations of the web pages are longer than a preset duration threshold.

In the counting module 11, the end of the period may be determined by setting a timer, or automatically timing based on a system time of a server. The period may be set as 10 days, one month, etc.

The historical internet address database set for the target user may be directly set in the server. The server stores each internet address browsed by a terminal user into the historical internet address database during the period The simple implementation of storing internet address may include: actively reporting, by the browser, the internet address corresponding to the web page currently accessed and opened by the user to the server when the user browses the web page through a browser in a terminal; and storing, by the server, based on a logged-in user account on the browser, the actively reported internet address into the historical internet address database corresponding to the user account, where the stored internet address is a historical internet address accessed by the user.

Alternatively, the historical internet address database set for the target user may be set in a terminal. In the period, the terminal obtains the internet address corresponding to a web page accessed and opened through a browser in a terminal. Further, the terminal stores, based on a logged-in user account on the browser, the corresponding internet address into the historical internet address database corresponding to the user account. At the end of the period, the terminal reports the whole stored historical internet address database to the server, and the server counts the number of loadings of each internet address in the historical internet address database.

In the counting module 11, the number of loadings of each internet address in the historical internet address database may be counted with the following approach: according to a storage order of the historical internet addresses in the historical internet address database, comparing a current historical internet address with at least one previous internet address one by one; if the current historical internet address is the same as one of previous internet addresses, adding 1 to the number of loadings of the previous historical internet address; and by this analogy, obtaining the number of loadings of each historical internet address in the historical internet address database.

The historical internet address includes home page internet addresses of various web portals, forums, etc., and all internet subdomain addresses linked to the homepage internet addresses. In the step 101, the number of loading of each historical internet address is counted.

The historical internet address is an internet address of a web page displayed on the foreground by the browser, where the display durations is longer than the preset duration threshold, for example, longer than one minute. The internet address of the web page which is not displayed on the foreground or displayed with short durations are not processed, because this internet address may be clicked by the user by error, or may be pop-up advertisement, etc. Thus, the time for counting and processing is reduced by removing the internet address.

The historical internet address with the small number of loadings may be accidentally accessed by the user sometime or on a certain day based on requirements for work, study or life. The historical internet address with the small number of loadings may not be processed or may be deleted. As for the historical internet address with the large number of the loadings, for example, some historical internet addresses are loaded 20 times in a period of 10 days, it may be determined that the user likes and pays attention to those historical internet addresses. The extraction module 12 may extract those historical internet addresses with the large number of the loadings, and the pushing module 13 sends the push message based on those historical internet addresses.

The historical internet address with the number of loadings larger than the preset number threshold are extracted at the end of the period; and then in the case that the server detects an access requirement sent when the terminal of the target user opens the browser, or a notification of the open of the browser actively reported to the server, the pushing module 13 sends the push message to the terminal of the target user. After receiving the push message, the terminal displays, to the user, whether at least one extracted historical internet address is set as the quick link internet address.

In the case that a lot of historical internet addresses are extracted by the extraction module 12, the pushing module 13 may send a push message, in which only one or a few of historical internet addresses with the largest number of loadings are displayed.

Optionally, referring to FIG. 5 again, the device may further include an obtaining module 14.

The obtaining module 14 is adapted to obtain the internet address of the web page, where the web page is displayed on the foreground by a browser and the display duration thereof is longer than a preset duration threshold; and record the obtained internet address into a historical internet address database established for user information of the target user logging in the web page in the browser.

Referring to FIG. 6, the obtaining module 14 may include: a first detection module 141 and a first record module 142.

The first detection module 141 is adapted to, in the case that the browser in the terminal of the target user searches for a key word by a search engine, detect whether the display duration of the web page corresponding to an internet address clicked and opened from a search result is longer than the preset duration threshold.

The first record module 142 is adapted to in the case that the display duration is longer than the preset duration threshold, record the clicked internet address into the historical internet address database established for the user information of the target user logging in the browser.

The obtaining module 14 may further include: a second detection module 143 and a second record module 144.

The second detection module 143 is adapted to detect the internet address inputted in an address bar of the browser in the terminal of the target user.

The second record module 144 is adapted to, after the browser opens the web page corresponding to the inputted internet address, in the case that the display duration of the web page displayed on the foreground is longer than the preset duration threshold, record the inputted internet address into the historical internet address database established for the user information of the target user logging in the browser.

The obtaining module 14 may further include: a third detection module 145 and a third record module 146.

The third detection module 145 is adapted to detect the clicked internet address in a site navigation of the browser in the terminal of the target user.

The third record module 146 is adapted to, after the browser opens the web page corresponding to the clicked internet address in the site navigation, in the case that the display duration of the web page displayed on the foreground is longer than the preset duration threshold, record the clicked internet address into the historical internet address database established for the user information of the target user logging in the browser.

The obtaining module 14 may include any one or any combination of the first detection module 141 and the first record module 142; the second detection module 143 and the second record module 144; and the third detection module 145 and the third record module 146.

It should be noted that the device according to the embodiment of the disclosure may be directly set in intelligent terminals such as smart phone, tablet computers, etc.

According to the embodiment of the disclosure, the number of loadings of the historical internet address browsed by the target user may be counted automatically to automatically prompt the user to set the internet address with the large number of loadings as the quick link internet address, which may be loaded directly and rapidly when browsing next time. In this way, the requirement of the user on intelligentized and automatic statistics of the quick link internet address is satisfied, and it is advantageous for the user to add the quick link internet address.

Referring FIG. 7, which illustrates a schematic structure diagram of another prompt device for adding a quick link in a browser according to an embodiment of the disclosure, the device according to the embodiment may be applied in intelligent terminals such as smart phone, tablet computers, etc. The device includes an internet address obtaining module 21, a duration detection module 22 and a sending module 23.

The internet address obtaining module 21 is adapted to obtain an internet address of a web page displayed by the browser in the case that the browser is opened.

The duration detection module 22 is adapted to detect a display duration of the web page displayed on the foreground by the browser.

The sending module 23 is adapted to, in the case that the display duration is equal to a preset duration threshold, send the internet address to a server, where the server stores the internet address into a historical internet address database of the server.

The internet address obtaining module 21 may be adapted to determine whether the user opens the browser based on system processes, and obtain the internet address currently requested and loaded by the browser based on a running condition of the browser in the kernel. The duration detection module 22 may be adapted to time the duration when the requested internet address starts to be displayed on the foreground by the browser.

The sending module 23 may be adapted to, when the duration, in which the web page corresponding to the currently loaded internet address is displayed on the foreground by the browser, is equal to the preset duration threshold, directly send the currently loaded internet address to the server, and the server stores the currently loaded internet address into the historical internet address database which is located on the server and is preset for the user of the browser. Alternatively, the sending module 23 may firstly store the currently loaded internet address into the historical internet address database of the terminal, then send the historical internet address database including the currently loaded internet address to the server at the end of the period, and the server may accordingly records the historical internet address database including the currently loaded internet address.

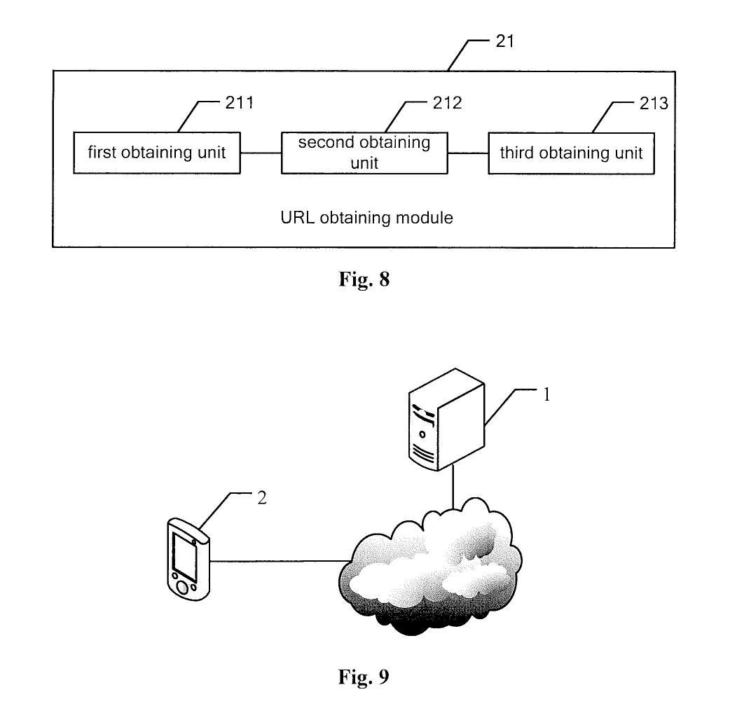

Referring to FIG. 8, the internet address obtaining module 21 may include: a first obtaining unit 211, a second obtaining unit 212 and a third obtaining unit 213.

The first obtaining unit 211 is adapted to, in the case that the browser searches for a key word by a search engine, obtain an internet address clicked and loaded from a search result.

The second obtaining unit 212 is adapted to, in the case that the browser searches for a key word by a search engine, obtain an internet address inputted in an address bar of the browser.

The third obtaining unit 213 is adapted to, in the case that the browser searches for a key word by a search engine, obtain an internet address clicked in a site navigation of the browser.

Optionally, referring to FIG. 7 again, the device according to the embodiment of the disclosure may further include: a receiving module 24, a display module 25 and a display module 25.

The receiving module 24 is adapted to receive a push message generated and sent by the server.

The display module 25 is adapted to add the push message to the browser and display the push message to the user, where the push message is adapted to prompt the user to set at least one historical internet address as a quick link internet address; and

The setting module 26 is adapted to, in the case that an operation of clicking and confirming the push message is received, set the at least one clicked and confirmed historical internet address as the quick link internet address.

The setting module 26 may add the at least one historical internet address clicked and confirmed by the user into Favorites of the browser to achieve the set of the quick link internet address.

According to the embodiment, the internet addresses browsed through the browser in the terminal of the user may be obtained rapidly and filtered initially; then the filtered internet addresses are sent to the server to automatically prompt the user to set the internet addresses with the large numbers of loadings as the quick link internet addresses. After receiving prompt information from the server, the terminal may display the prompt information to the user, and prompt the user to select at least one internet address from the prompt information as the quick link internet address. In this way, the requirement of the user on intelligentized and automatic statistics of the quick link internet address is satisfied, and it is advantageous for the user to add the quick link internet address.

Referring FIG. 9, which illustrates a schematic structure diagram of a prompt system of a browser according to an embodiment of the disclosure, the system according to the embodiment of the disclosure includes a user terminal 2 and a server 1.

The user terminal 2 is adapted to, obtain an internet address in the case that the browser is opened; detect a display duration of the web page displayed on the foreground by the browser; in the case that the display duration is equal to a preset duration threshold, send the internet address to the server 1.

The server 1 is adapted to store the received internet address into a historical internet address database of the server 1, where the historical internet address database is adapted to record internet addresses of web pages, where the web pages are displayed on the foreground by a browser during a period and display durations of the web pages is longer than a preset duration threshold.

The server 1 is further adapted to obtain a historical internet address database set for a target user at the end of the period, and count the number of loadings of each historical internet address in the historical internet address database in the period; extract the historical internet address with the number of loadings larger than a preset number threshold; send a push message based on the extracted historical internet address to send a prompt of adding the quick link to the target user when the browser in the user terminal 2 is opened, where the push message is adapted to prompt the user to set at least one extracted historical internet address as a quick link internet address.

The user terminal 2 is further adapted to receive the push message generated and sent by the server 1, and add the push message to the browser and display the push message to the user; in the case that an operation of clicking and confirming the push message is received, set the at least one clicked and confirmed historical internet address as the quick link internet address.

According to the embodiment of the disclosure, the server 1 may include the devices according to the embodiments corresponding to FIG. 5 and FIG. 6. The user terminal 2 may include the devices according to the embodiments corresponding to FIG. 7 and FIG. 8.

According to the embodiment of the disclosure, the number of loadings of the historical internet address browsed by the target user may be counted automatically to automatically prompt the user to set the internet address with the large number of loadings as the quick link internet address, which may be loaded directly and rapidly when browsing next time. In this way, the requirement of the user on intelligentized and automatic statistics of quick link internet address is satisfied, and it is advantageous for the user to add the quick link internet address.

It should be understood by those skilled in the art that all or part of the processes in the methods according to the embodiments of the disclosure may be implemented by a corresponding hardware instructed with a program, where the program may be stored in a non-transitory computer readable storage medium; the program may include the processes according to all the method embodiments. The non-transitory computer readable storage medium may include: magnetic disk, Compact Disk, Read Only Memory (ROM), Random Access Memory (RAM), etc.

Only preferred embodiments of in disclosure are disclosed, and obviously the disclosed embodiments are not intended to limit the scope of what is claimed; therefore, equivalent changes based on what is claimed of the disclosure should fall in the scope of protection of the disclosure.

What is claimed is:

1. A method implemented by a server that includes a processor for adding a quick link in a browser executing in a terminal having a processor, the method comprising:
from a historical internet address database comprising a plurality of internet addresses for web pages displayed on a foreground of the browser for a respective display duration longer than a preset duration threshold, counting by the server a respective number of display times the each of the plurality of historical internet addresses was displayed during a period;
extracting by the server the one of the plurality of historical internet addresses with the respective of number of display times larger than a preset number threshold; and
sending a push message based on the extracted historical internet address to send to the target user a prompt of adding the quick link when the browser in the terminal of the target user is opened, wherein the push message is adapted to prompt the user to set at least one extracted historical internet address as a quick link internet address.

2. The method of claim 1, further comprising:
establishing by the server the historical internet address database from user information of a target user logged in the browser and recording by the server the plurality of internet addresses.

3. The method of claim 2 further comprising obtaining from the terminal the plurality of internet addresses and recording into the historical internet address database the plurality of internet addresses.

4. The method of claim 2 further comprising:
in the case that the browser in the terminal of the target user searches for a key word by a search engine, determining whether the display duration of the web page corresponding to a clicked and loaded internet address from a search result is longer than the preset duration threshold; and
in the case that the display duration is longer than the preset duration threshold, recording the clicked internet address into the historical internet address database established for the user information of the target user logging in the browser.

5. The method of claim 3, wherein obtaining a one of the plurality of internet addresses comprises:
detecting the internet address inputted in an address bar of the browser in the terminal of the target user; and
after the browser loads the web page corresponding to the inputted internet address, in the case that the display duration of the web page displayed on the foreground is longer than the preset duration threshold, recording the inputted internet address into the historical internet address database established for the user information of the target user logging in the browser.

6. The prompt method according to claim 3, wherein obtaining a one of the plurality of internet addresses comprises:
detecting an internet address clicked in a site navigation of the browser in the terminal of the target user; and
after the browser loads the web page corresponding to the internet address clicked in the site navigation, in the case that the display duration of the web page displayed on the foreground is longer than the preset duration threshold, recording the clicked internet address into the historical internet address database established for the user information of the target user logging in the browser.

7. A method for adding a quick link in a browser executing in a terminal having a processor, the method comprising:
obtaining by the terminal an internet address of a web page displayed by the browser;
detecting a display duration of the web page by the browser; and
in the case that the display duration is equal to a preset duration threshold, sending by the terminal the internet address to a server.

8. The method of claim 7, wherein obtaining the internet address of a web page displayed on the browser comprises:
in the case that the browser searches for a key word by a search engine, obtaining an internet address clicked and loaded from a search result;
obtaining an internet address inputted in an address bar of the browser; or
obtaining an internet address clicked in a site navigation of the browser.

9. The method of claim 7, further comprising:
receiving a push message generated and sent by the server, adding the push message to the browser, and displaying the push message to a user; and
in the case that an operation of clicking the push message is received, setting at least one clicked historical internet address as the quick link internet address;
wherein the push message is adapted to prompt the user to set the at least one historical internet address as the quick link internet address.

10. The method of claim 8, wherein the method further comprises:
receiving a push message generated and sent by the server, adding the push message to the browser, and displaying the push message to a user; and
in the case that an operation of clicking the push message is received, setting at least one clicked historical internet address as the quick link internet address;
wherein the push message is adapted to prompt the user to set the at least one historical internet address as the quick link internet address.

11. A device for adding a quick link in a browser, the device comprising:
a server;
a counting module adapted to obtain a historical internet address database for a target user at the end of a period and count the number of loadings of each historical internet address in the historical internet address database in the period;
an extraction module adapted to extract from historical internet address database an historical internet address with the number of loadings larger than a preset number threshold; and
a pushing module adapted to send a push message based on the extracted historical internet address to send to the target user a prompt of adding the quick link when the browser in a terminal of the target user is opened, wherein the push message is adapted to prompt the user to set at least one extracted historical internet address as a quick link internet address;
wherein the historical internet address database is adapted to record internet addresses of web pages displayed by the browser during the period for display durations that are longer than a preset duration threshold.

12. The prompt device according to claim 11, wherein the device further comprises:
an obtaining module adapted to obtain the internet address of web page, wherein the web page is displayed on the foreground by a browser and a display duration of the web page is longer than a preset duration threshold; and record the obtained internet address into a historical internet address database established for user information of the target user logging in the browser.

13. The prompt device according to claim 12, wherein the obtaining module comprises:
a first detection unit adapted to, in the case that the browser in the terminal of the target user searches for a key word by a search engine, detect whether the display duration of the web page corresponding to an internet address clicked and loaded from a search result is longer than the preset duration threshold; and
a first record unit adapted to, in the case that the display duration is longer than the preset duration threshold, record the clicked internet address into the historical internet address database established for the user information of the target user logging in the browser.

14. The prompt device according to claim 12, wherein the obtaining module comprises:
a second detection module adapted to detect the internet address inputted in an address bar of the browser in the terminal of the target user; and
a second record module adapted to, after the browser loads the web page corresponding to the inputted internet address, in the case that the display duration of the web page displayed on the foreground is longer than the preset duration threshold, record the inputted internet address into the historical internet address database established for the user information of the target user logging in the browser.

15. The prompt device according to claim 12, wherein the obtaining module comprises:
a third detection module adapted to detect the internet address clicked in a site navigation of the browser in the terminal of the target user; and
a third record module adapted to, after the browser loads the web page corresponding to the internet address clicked in the site navigation, in the case that the display duration of the web page displayed on the foreground is longer than the preset duration threshold, record the clicked internet address into the historical internet address database established for the user information of the target user logging in the browser.
